(19) United States
(12) Patent Application Publication
(10) Pub. No.: US 2007/0082975 A1
(43) Pub. Date: Apr. 12, 2007

(54) Friction material and method of manufacturing the same

(76) Inventors: Masaaki Kobayashi, Obu-shi (JP); Hiroyuki Fujikawa, Nagoya-shi (JP); Yuji Komori, Nagoya-shi (JP)

Correspondence Address: BUCHANAN, INGERSOLL & ROONEY PC, POST OFFICE BOX 1404, ALEXANDRIA, VA, 22313-1404, US

(21) Appl. No.: 11/523,536

(22) Filed: Sep. 20, 2006

(30) Foreign Application Priority Data
Oct. 12, 2005 (JP) 2005-297539

(51) Int. Cl. C08J 5/14

(52) U.S. Cl. 523/149

(57) ABSTRACT

A friction material includes base fibers, a friction conditioner, a binder and enlarged dust. The enlarged dust is a combination of grinding dust and an elastic material such as rubber.

This application claims priority to Japanese patent application serial number 2005-297539, the contents of which are incorporated herein by reference.

### BACKGROUND OF THE INVENTION

The present invention relates to a friction material, such as a brake pad or lining, or a clutch facing. More particularly, the invention relates to a friction material made of raw materials containing grinding dust produced during the manufacture of friction materials, or particles of waste friction materials, and a method of manufacturing the same.

A friction material, such as a brake pad, or lining, is manufactured by mixing base fibers, a friction conditioner and a binder, molding their mixture under heat and pressure and grinding the molded body to proper dimensions. Accordingly, grinding or polishing dust is unavoidably produced during the manufacture of a friction material. It has been usual to dispose of such grinding dust by using it as a raw material for cement after firing, or as land reclamation.

Solutions have been proposed wherein the friction material contains (as a raw material) a powder obtained by heat treating a waste friction material (i.e. a used or defective brake pad) and pulverizing it. The waste friction material is porous because of the removal of organic matter by heat treatment at a high temperature. Accordingly, the friction material has a high degree of porosity and a high fade possibility.

However, the thermosetting resin which grinding dust contains as a binder is in its hardened state, since the dust is molded under heat to make a friction material. Therefore, the use of such grinding dust in making a friction material is likely to result in a hard friction material producing brake noise or other unusual noise. This problem cannot be solved even by the prior proposals.

Grinding dust has a small particle diameter and it tends to be smaller than that of cashew dust employed as one of raw materials for a friction material to improve its damping property. Accordingly, cashew dust in grinding dust has a smaller particle diameter than usual, and therefore, a lower level of damping property. This can be one of the possible causes for brake noise or other abnormal sound.

Since the grinding dust has a small particle diameter, the dust is difficult to handle in a process for manufacturing a friction material.

### SUMMARY OF THE INVENTION

The present invention is concerned with a friction material manufactured from a raw material containing grinding dust occurring from the manufacture of a friction material, or obtained by grinding a waste friction material, and is aimed at providing a friction material which is easy to manufacture by using such grinding dust in a way restraining any brake noise or other unusual noise.

In one aspect of the present invention, a friction material includes base fibers, a friction conditioner, a binder and enlarged dust produced by combining grinding dust with an elastic material such as rubber. The grinding dust is obtained from grinding, polishing or cutting of the friction material during the manufacture thereof. The process of combining the grinding dust with the elastic material can be generally described as granulation or pelletization.

Therefore, the enlarged dust is easier to handle owing to its particle diameter enlarged by combination with the rubber. The rubber in the enlarged dust raises the damping property of the friction material and further restrains brake noise and any other unusual noise. Moreover, a careful study indicates that the friction material is satisfactorily high in coefficient of friction and wear resistance.

In another aspect of the present invention, the grinding dust is combined with rubber and a phenol resin mixture. Thus, the enlarged dust contains a phenol resin in addition to rubber. The bonding force of the phenol resin bonds the enlarged dust to the other components of the friction material and thereby improves its wear resistance.

In another aspect of the present invention, the grinding dust and rubber, or the grinding dust and the rubber and phenol resin mixture have a weight ratio of 25:75 to 90:10. Thus, the amount of grinding dust is sufficiently large to realize a high percentage of reuse and the amount of rubber is sufficiently large to bond with the grinding dust.

In another aspect of the present invention, the friction member is made up enlarged dust between 5 to 50% of the entire friction member volume. Thus, a sufficient reuse of grinding dust is possible, and further the rubber in the enlarged dust raises the damping property of the friction material and thereby restrains any brake noise or other unusual noise satisfactorily.

In another aspect of the present invention, the rubber with which the grinding dust is combined is unvulcanized rubber. Thus, the unvulcanized rubber improves vibration-absorbing property of the friction material. Further, it restrains any brake noise or other unusual noise satisfactorily.

In another aspect of the present invention, the rubber with which the grinding dust is combined is vulcanized rubber. The vulcanized rubber improves heat resistance of the friction material.

In another aspect of the present invention, raw materials of the friction material (other than the enlarged dust) are free from any cashew dust.

While cashew dust is usually employed to improve the damping property of the friction material, the friction material includes enlarged dust having rubber. Accordingly, the friction material relies on the rubber, instead of cashew dust, for achieving an improved damping property and for restraining any brake noise or other unusual noise satisfactorily.

### DESCRIPTION OF THE DRAWINGS

FIG. 1 shows raw materials of friction materials of examples 1 to 8 and comparative examples 1 to 4, mixing ratios of the raw materials and test results of the friction materials.

### DETAILED DESCRIPTION OF THE INVENTION

Each of the additional features and teachings disclosed above and below may be utilized separately or in conjunction with other features and teachings to provide improved friction materials. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful configurations of the present teachings.

The friction material according to the present invention comprises base fibers, a friction conditioner, a binder and enlarged dust which is produced by combining grinding dust with an elastic material such as rubber.

The grinding dust (also know as friction material dust) is a result of polishing, grinding or cutting of the friction member produced during the manufacture thereof, or dust obtained by grinding or milling of used or defective brake pads. The grinding dust produced during the manufacture of a friction material is the dust produced, for example, when a molded friction material obtained by molding a mixture of the base fibers, a friction conditioner and a binder is polished to the desired dimensions. The grinding dust has a small average particle diameter substantially between 2 to 20 μm.

The grinding dust is not reused directly as a raw material for the friction material, but is reused in the form of a enlarged body obtained by its combination with rubber. A common rubber, such as NBR (acrylonitrile-butadiene rubber), SBR (styrene-butadiene rubber), BR (butadiene rubber), EPDM, butyl rubber, acrylic rubber or silicone rubber, can be used as the rubber to combine with grinding dust. Hydrogenated NBR, EPDM, acrylic rubber, bromobutyl rubber, silicone rubber, fluorine-containing rubber, etc. are preferably used for their high heat resistance. The rubber may or may not be vulcanized.

The enlarged dust may also contain phenol resin along with rubber and grinding dust. The rubber and phenol resin may be employed in a weight ratio of, say, 50:50 to 80:20. Zinc white, stearic acid, sulfur, a vulcanization accelerator, etc. can also be added at the time of combining. It is preferable to add 2 to 8 parts by weight of zinc white, 1 to 5 parts by weight of stearic acid, 0.1 to 1 parts by weight of sulfur and 1 to 5 parts by weight of a vulcanization accelerator to 100 parts by weight of rubber. No vulcanization accelerator is added when rubber is an unvulcanized one.

The grinding dust and the rubber or its mixture with the phenol resin preferably have a weight ratio of from 25:75 to 90:10. The lower limit of their weight ratio is more preferably 50:50 and still more preferably 60:40, and its upper limit is more preferably 85:15 and still more preferably 80:20.

Enlarged dust is created by mixing, graining or pelletizing grinding dust and rubber, and/or a phenol resin, and any other material as stated above, in a kneading machine. The enlarged dust is formed into appropriately sized pellets by a disk pelleter and a rotary pelletizer. The kneading machine may be an apparatus used for kneading rubber, such as a kneader, an open mill, a Banbury mixer or an extruder. The pellets have a diameter of from 0.3 to 5 mm, preferably from 0.5 to 3 mm and more preferably from 1 to 2 mm.

Inorganic or organic fibers may be selected as the base fibers. Steel, copper, glass, ceramics or potassium titanate fibers can, for example, be used as inorganic fibers, and aramid fibers, for example, as organic fibers. The base fibers may be of a single kind, or a mixture of two or more kinds of fibers. The base fibers are used in the form of short fibers or particles preferably in an amount occupying 10 to 50% of the friction material volume.

The friction conditioner (filler) is employed, for example, to adjust the coefficient of friction, suppress any unusual noise and prevent rust, and may contain an inorganic or organic filler, a lubricant, etc. Examples of the inorganic fillers are zirconium silicate, zirconium oxide (zirconia), silicon carbide, silica, alumina, barium sulfate, calcium carbonate, calcium hydroxide, mica, kaolin and talc. Examples of the organic fillers are cashew dust and rubber dust. Examples of the lubricants are graphite, antimony trisulfide, molybdenum disulfide and zinc disulfide.

The friction conditioner may be of a single kind, or a combination of two or more kinds. While cashew dust is a material employed to improve damping property, the present invention relies on the rubber-granulated body of the grinding dust for its improved damping property. Therefore, the friction member according to the present invention may or may not contain cashew dust in its raw materials.

Examples of the binders are a phenol resin, an imide resin, a rubber-modified phenol resin, a melamine resin, an epoxy resin, NBR, nitrile rubber and acrylic rubber. The binder may be of a single kind, or a combination of two or more kinds. The binder preferably occupies 5 to 30% of the friction material volume.

The manufacture of a friction material is started by combining the grinding dust with rubber, or with rubber and a phenol resin to prepare enlarged dust. The enlarged dust, base fibers, a friction conditioner and a binder are mixed by a mixer to form a raw material mixture. The mixer may be, for example, an Einrich, universal or Lodige mixer.

Then, the raw material mixture is pre-molded with a pre-molding die to form a pre-molded body. The pre-molded body is molded under pressure and heat with a molding die to form a molded body. The molding temperature is from 130° C. to 200° C., the molding pressure is from 10 to 100 MPa and the molding time is from 2 to 15 minutes.

Then, the molded body is heat treated at 140° C. to 400° C. for 2 to 48 hours. The molded body is ground to the desired dimensions to give a complete friction material.

Examples of the present invention and comparative examples will now be described.

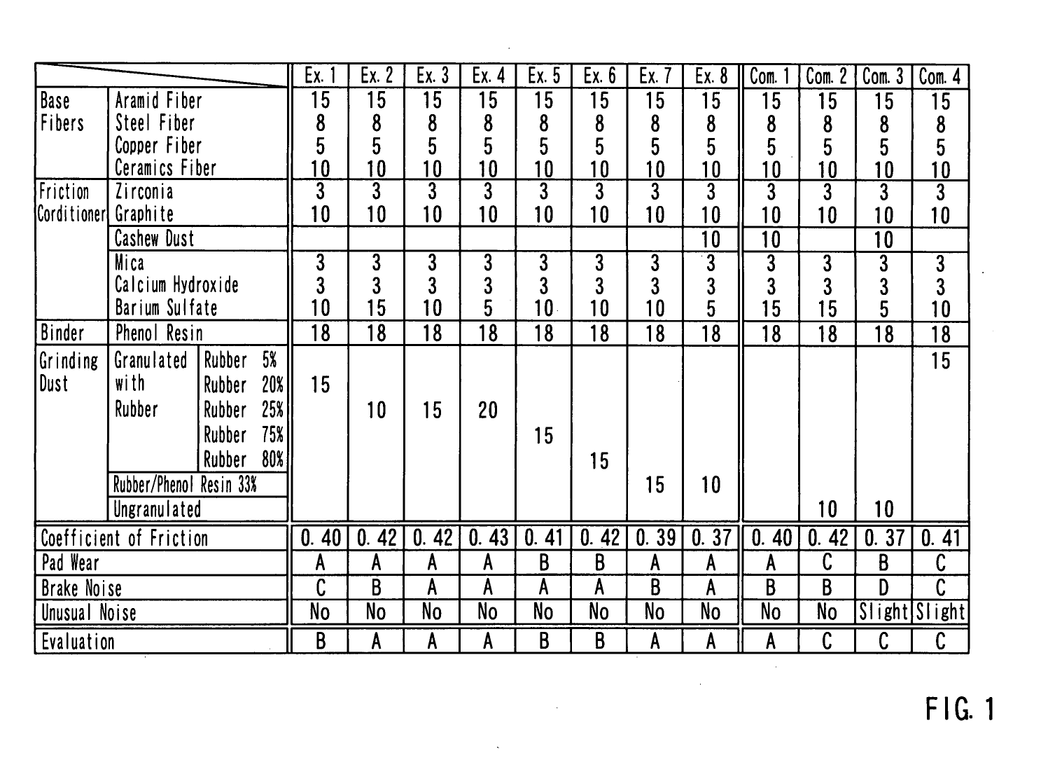

Friction materials according to the present invention (Examples 1 to 8) and comparative friction materials (Comparative Examples 1 to 4) were prepared by employing the raw materials shown in FIG. 1 in the mixing ratios also shown therein and were tested for various properties.

In FIG. 1, “Ex. 1” to “Ex. 8” and “Com. 1” to “Com. 4” stand for the friction materials of Examples 1 to 8 and Comparative Examples 1 to 4, respectively.

Comparative Example 1 was a standard material molded by employing the raw materials in the mixing ratio as shown in FIG. 1. Examples 1 to 8 and Comparative Example 4 includes grinding dust which was produced during the manufacture of the friction material of Comparative Example 1.

Each of Examples 1 to 6 contained enlarged dust obtained by combining grinding dust with rubber. The enlarged dust in Examples 7 and 8 contain grinding dust, rubber, and phenol resin.

The enlarged dust in Example 1 includes a rubber content of approximately 20%, or a grinding dust to rubber weight ratio of 80:20. The enlarged dust is approximately 15% of the friction material volume.

SBR (product of Asahi Kasei known by the trademark, Tafdene 2000R) and BR (product of Asahi Kasei known by the trademark, Diene NF35R) were used as rubbers for combining with the grinding dust. The enlarged dust was obtained by kneading 70 parts by weight of SBR, 30 parts by weight of BR, 5 parts by weight of zinc white, 2 parts by weight of stearic acid, 0.5 part of sulfur, 3 parts of a vulcanization accelerator and 400 parts by weight of grinding dust in a pressure kneader. The enlarged dust was formed into pellets having a diameter of 1 to 2 mm by a disk pelleter (of Fuji Paudal) and a rotary pelletizer (of Horai).

Then, the base fibers, friction conditioner, binder, and enlarged dust of grinding dust as shown in FIG. 1 were mixed in the mixing ratio shown in FIG. 1 by a universal mixer in the dry state to prepare a raw material mixture.

The raw material mixture was pre-molded in a pre-mold and the pre-molded body was molded in a mold under a temperature of 160° C. and a pressure of 20 Mpa for 10 minutes. Then, the molded body was heat treated at 210° C. for three hours in an oven to give a complete friction material (brake pad).

The enlarged dust in Examples 2 to 4 have a rubber content of approximately 25%, or a grinding dust to rubber weight ratio of 75:25. More specifically, it was obtained by employing 300 parts by weight of grinding dust instead of 400 parts in Example 1. The enlarged dust in Examples 2 to 4 may be approximately 10%, 15% or 20% of the friction material volume. Examples 2 to 4 were manufactured by the same way as Example 1.

The enlarged dust in Example 5 has a rubber content of approximately 75%, or a grinding dust to rubber weight ratio of 25:75. More specifically, it was obtained by employing 33 parts by weight of grinding dust instead of 400 parts in Example 1. The enlarged dust in this Example may be approximately 15% of the friction material volume. Example 5 was manufactured by the same way as Example 1.

The enlarged dust in Example 6 has a rubber content of approximately 80%, or a grinding dust to rubber weight ratio of 20:80. More specifically, it was obtained by employing 25 parts by weight of grinding dust instead of 400 parts in Example 1. In this Example, the enlarged dust may be approximately 15% of the friction material volume. Example 6 was manufactured by the same way as Example 1.

The enlarged dust in each of Examples 7 and 8 contains approximately 33% of rubber and a phenol resin, or having a weight ratio of 67:33 between the grinding dust and the rubber and phenol resin combination. The phenol resin (Sumilite Resin PR310 of Sumitomo Bakelite) was added to the raw materials of the granulated body employed in Example 1 when they were kneaded to obtain the enlarged dust in Examples 7 and 8. The enlarged dust might occupy approximately 15% or 10% of the friction material volume. Examples 7 and 8 were manufactured by the same way as Example 1.

Example 8 also contains 10 vol. % of cashew dust. None of Examples 1 to 7 contains cashew dust.

Comparative Example 1 was made by employing raw materials not containing any grinding dust, and otherwise repeating Example 1.

Comparative Examples 2 and 3 were each made by employing ungranulated grinding dust. The dust might occupy 10 vol. % of the friction material. Comparative Examples 2 was manufactured by the same way as Example 1. Comparative Example 3 contained 10 vol. % of cashew dust.

Comparative Example 4 contains enlarged dust having a rubber content of approximately 5%, or a grinding dust to rubber weight ratio of 95:5. More specifically, it was obtained by employing 1,900 parts by weight of grinding dust instead of 400 parts in Example 1. The enlarged dust may be approximately 15% of the friction materials volume. Comparative Example 4 was manufactured the same way as Example 1.

Examples 1 to 8 and Comparative Examples 1 to 4 were tested for their properties and the results are shown in FIG. 1. Their results were determined as described below.

Coefficient of Friction (Average μ of Second Effectiveness Test): Each material had its average coefficient of friction determined by a second effectiveness test conducted by a full-size dynamo tester at a velocity of 50 km/h prior to braking in accordance with JASO C-406-87. JASO stands for the Japanese Automotive Standards Organization.

Pad Wear: Each pad had its coefficients of friction determined in accordance with JASO C-406-87 and had its wear measured thereafter. Its wear was graded in accordance with the criteria shown in Table 1.

TABLE 1
Criteria of Pad Wear

| | |
|---|---|
| A | Small wear (Good) |
| B | Somewhat large |
| C | Large (Unacceptable) |

Brake Noise: Each pad had a brake dynamo test conducted at a hydraulic pressure of 0.1 to 2 MPa and a rotor temperature of 40° C. to 200° C. to count a number of times of noise having a certain level of high frequency (500 Hz or higher). The results were graded in accordance with the criteria shown in Table 2.

TABLE 2
Criteria of Brake Noise

| | |
|---|---|
| A | No noise |
| B | Slight |
| C | Some |
| D | Frequent |

Unusual Noise: Each friction material was installed in a real vehicle and tested for any unusual noise (having a frequency of 300 Hz or lower).

Evaluation: The criteria for the overall evaluation of each material were, A: Any material that had a friction coefficient of 0.37 or higher, and was not inferior to that of Comparative Example 1 in any other properties; B: Any material that showed a somewhat large amount of wear, or produced some brake noise; C: Any material that showed a large amount of wear, or produced frequent brake noise, or a slight unusual noise.

The results of Examples 1 to 8 gave a good overall evaluation (A or B).

Examples 2 to 4 contain enlarged dust in an amount increasing from one Example to another and the results thereof show that a friction member containing a larger amount of enlarged dust produces less frequent brake noise and has a higher coefficient of friction. Examples 3 and 4 produced brake noise less frequently than Comparative Example 1 and Examples 2 to 4 had a higher coefficient of friction than that of any Comparative Examples.

Comparative Example 4 and Examples 1, 3, 5 and 6 contained a larger amount of rubber in the enlarged dust from one Example to another and the results thereof show that a friction member containing a larger amount of rubber produced brake noise less frequently. Examples 3, 5 and 6 produced brake noise less frequently than Comparative Example 1.

Examples 7 and 8 contained enlarged dust with phenol resis. The phenol resin can be expected to produce a greater bonding strength between the enlarged dust and any other component of the friction material and thereby realize a lower degree of wear on the friction material.

Comparative Examples 2 and 3 contained grinding dust in a non-granulated form and showed a higher degree of wear than Example 2 containing grinding dust in a granulated form. It, therefore, follows that the granulation of grinding dust with rubber enables a reduction of wear on the friction material.

Comparative Example 4 contained a smaller amount of rubber in the enlarged dust than any of Examples 1, 3, 5 and 6 and showed a higher degree of wear. It, therefore, follows that a larger amount of rubber in the enlarged dust enables a reduction of wear on the friction material.

It is not clear why the granulation of grinding dust with rubber enables a reduction of wear on the friction material, or why the use of a larger amount of rubber enables a further reduction of wear. It is, however, possible that, since grinding dust is formed from a friction material made by molding under heat and already contains a hardened thermosetting resin as a binder, the granulation of the dust with rubber may make it more compatible with the phenol resin as the binder and thereby realize a friction material of higher wear resistance.

Comparative Example 3 produced frequent brake noise and another slight unusual noise too.

Examples 1 to 7 did not contain any cashew dustand they produced satisfactorily low level of brake noise and does not produce any other unusual noise. This is resulting from having a satisfactorily large amount of grinding dust granulated with rubber.

The present invention is applicable to, for example, a brake pad or lining, or a clutch facing used in an industrial machine, a railway or freight vehicle, or an automobile.

This invention claims:

1. A friction material comprising:
base fibers;
a friction conditioner;
a binder; and
enlarged dust, wherein the enlarged dust is a combination of grinding dust and rubber.

2. The friction material as in claim 1, wherein the rubber is at least one of acrylonitrile-butadiene, styrene-butadiene, butadiene, EPDM, butyl, acrylic or silicone.

3. The friction material as in claim 1, wherein the grinding dust is dust obtained by manufacturing a friction member.

4. The friction material as in claim 1, wherein the grinding dust is obtained by grinding or milling a waste friction material.

5. The friction material as in claim 1, wherein a weight ratio of the grinding dust to the rubber is in a range of 25:75 to 90:10.

6. The friction material as in claim 1, wherein the enlarged dust further includes phenol resin.

7. The friction material as in claim 6, wherein a weight ratio of the grinding dust to the rubber and phenol resin mixture is in a range of 25:75 to 90:10.

8. The friction material as in claim 1, wherein the enlarged dust is 5 to 50% of the friction material volume.

9. The friction material as in claim 1, wherein the rubber is unvulcanized rubber.

10. The friction material as in claim 1, wherein the rubber is vulcanized rubber.

11. The friction material as in claim 1, wherein the friction material does not include cashew dust.

12. A method of manufacturing a friction material comprising:
obtaining grinding dust wherein the grinding dust is produced by manufacturing of another friction material;
preparing enlarged dust by mixing rubber and the grinding dust;
mixing the enlarged dust with base fibers, a friction conditioner and a binder to prepare a raw material mixture; and
molding the raw material mixture.

13. The method of manufacturing a friction material as in claim 12, wherein the manufacturing the another friction material is at least one of grinding, polishing and cutting.

14. The method of manufacturing a friction material as in claim 12, wherein the another friction material is a waste friction material.

15. The method of manufacturing a friction material as in claim 12, wherein a weight ratio of the grinding dust to the rubber is in a range of 25:75 to 90:10.

16. The method of manufacturing a friction material as in claim 12, wherein the enlarged dust further includes phenol resin.

17. The method of manufacturing a friction material as in claim 16, wherein a weight ratio of the grinding dust to the rubber and phenol resin mixture is in a range of 25:75 to 90:10.

18. The method of manufacturing a friction material as in claim 12, wherein the enlarge dust is 5 to 50% of the friction material volume.

19. A friction material comprising:
base fibers;
a friction conditioner;
a binder; and
enlarged dust, wherein the enlarged dust is a combination of grinding dust and rubber, further wherein the grinding dust is a byproduct of manufacturing of another friction material.

20. The friction material as in claim 19, wherein the enlarge dust further includes phenol resin.
